(19) United States
(12) Patent Application Publication
(10) Pub. No.: US 2010/0157995 A1
(43) Pub. Date: Jun. 24, 2010

(54) Method for Setting Up a Telephone Connection, and Apparatuses

(76) Inventors: Olaf Bigalke, Oberhausen (DE); Christoph Euscher, Rhede (DE); Werner Goertz, Dorsten (DE); Volker Mösker, Isselburg (DE)

Correspondence Address: STAAS & HALSEY LLP, SUITE 700, 1201 NEW YORK AVENUE, N.W., WASHINGTON, DC, 20005, US

(21) Appl. No.: 12/086,487

(22) PCT Filed: Sep. 25, 2006
(86) PCT No.: PCT/EP2006/009309

§ 371 Date: Jun. 13, 2008

(51) Int. Cl. H04L 12/66

(52) U.S. Cl. 370/356

(57) ABSTRACT

A first telephone connection from a first terminal to a second terminal is set up via a circuit-switched telephone network to send signaling from the second terminal to the first terminal via the first telephone connection, where the signaling signals the capability of the first terminal or of the second terminal to handle telephone data which are received via a data packet transmission network, or where the signaling contains connection data which relate to the availability of the signaling terminals in the data packet transmission network.

### CROSS REFERENCE TO RELATED APPLICATIONS

This application is based on and hereby claims priority to International Application No. PCT/EP2006/009309 filed on Sep. 25, 2006, the contents of which are hereby incorporated by reference.

### BACKGROUND

Described below is a method for setting up a telephone connection, with one of the steps being carried out as follows:

Setting up a first telephone connection from a first terminal, in particular a telephone, to a second terminal, in particular a telephone via a circuit-switched telephone network. At least a section, for example a section ending at the calling terminal or at the called terminal of the first telephone connection or the entire first telephone connection lies in the circuit-switched telephone network. The circuit-switched telephone network is for example an analog telephone network or a telephone network with analog connections for example for the first terminal or the second terminal. Alternatively, the circuit-switched telephone network is a digital telephone network, in which digitized voice data is transmitted in time division multiplex channels in the form of time frames. In particular, the circuit-switched telephone network can also be a mobile radio network or the circuit-switched part of a mobile radio network.

Telephoning via packet data transmission networks is well known, for example via the Internet. A user of a telephone device who can telephone via both telephone networks, for example decides, before calling, which telephone network he wants to use. A switchover method between telephone connections is for example known from EP 1 681 844 A1.

### SUMMARY

It is nevertheless an aspect to provide a simple method for setting up a telephone connection. In particular, a simple method shall be provided for changing a telephone connection in a circuit-switched network to a telephone connection in a packet-switched network. This process is to involve the minimum disruption to the user, either by additional user actions or by additional signaling. In addition, associated apparatuses shall be provided.

In addition to the procedural step as mentioned in the introduction, the following step is carried out in the case of the method described below:

Via the first telephone connection, preferably automatically, sending signaling from the second terminal to the first terminal or, preferably automatically, sending signaling from the first terminal to the second terminal, with the signaling indicating the capability of the first terminal or of the second terminal to handle telephone data which is received via a packet-switched network, or with the signaling contains connection data relating to the availability of the signaling terminal in the packet-switched network.

The method is based on the ideas given below in order to achieve for example a fully automatic transfer of a POTS/ISDN call (Plane Old Telecommunication System/Integrated Services Digital Network) to VoIP (Voice over IP) in particular by inband signaling of the VoIP connection data. The caller, i.e. the initiator of a call, does not always know for certain whether the called party has in addition to his circuit-switched connection, for example his fixed network connection, a VoIP connection by which the call could possibly be made less expensively or even free of charge if a VoIP terminal is available on both sides. An automatic signaling of the VoIP capability and/or the VoIP subscriber number/VoIP-URI and/or the IP address as well as the IP port number if necessary would elegantly solve the problem in devices which support both telephone systems, and could directly initiate a handover or a transfer.

The method is furthermore based on the idea that an automatic signaling was previously not available, which means that a VoIP telephone number would either have to be known before setting up a connection, which would then explicitly have to be called. Alternatively, the call was relayed via a known telephone network, with VoIP subscriber numbers then being able to exchanged by voice during the call. In the case of further calls, the less expensive VoIP calls can then be made.

For example, if a circuit-switched call is set up, in one embodiment, the counterpart or its terminal is informed that there is a communication possibility via VoIP via a defined inband signaling (for example by DTMF tones (Dual Tone Multi-Frequency), FSK (Frequency Shift Keying) or a signaling in the control channel for example per UUS (User-to-User Signaling) in the ISDN. If the other subscriber also has to be reached via VoIP, the same signaling path is used to inform the opposite terminal or its terminal of the VoIP telephone number and/or the current IP address (Internet Protocol). If necessary, the telephone is muted during the signaling phase. After further inquiry at the user or also automatically, the call is now converted from a circuit-switched call into a VoIP call, a process that is also referred to as a handover or transfer.

Thus, in order to disturb the user as little as possible or to have to transmit as little data as possible, in particular for the case in which only one terminal has VoIP capabilities, it is first of all signaled that only one terminal has the capability to make VoIP calls. However, it does not yet convey which connection data would have to be used in this case; this takes place for example only after the second terminal has likewise communicated its capability to make VoIP calls.

In a development of the method, the signaling is sent automatically, i.e. in particular without being initiated manually. The co-operation of the subscriber is limited at the most to a further inquiry or confirmation, not however on the active actuation of sending.

In a development of the method, the signaling however contains connection data which relates to the availability of the signaling terminal in the data transmission network, for example all necessary connection data. This allows the terminal receiving the signaling to immediately set up a VoIP connection to the signaling terminal, if necessary after asking the user.

In a development of the method, the connection data is used by the terminal receiving the signaling for setting up a second telephone connection via the packet-switched network. In one embodiment, this telephone connection is set up automatically, in particular without further inquiry at the user. This is possible because it can be assumed that the user has no objections against using the same telecommunications service, however, for example at a lower price. On the other hand, a short further inquiry could give the user the possibility of preventing the setting up of a second telephone connection, for example because the user attaches great importance to the voice quality.

In another development, the first telephone connection is cleared automatically after the setting up of a second telephone connection, preferably while the second telephone connection is still in existence. This means that measures are no longer necessary for the data transmission for the first telephone connection, so that also no costs are incurred any longer in this respect for the user or the subscriber.

In another development of the method, the signaling is a preliminary signaling, which contains a code which indicates that the signaling terminal has the capability to also process telephone data, which will be transmitted via the packet-switched network. The preliminary signaling contains less data than the connection data needed by the terminal receiving the signaling to set up a connection via the packet-switched network. This means that the preliminary signaling is comparatively short, in particular less than 100 milliseconds or even less than 50 milliseconds. Such short signaling is for example only slightly disturbing in the voice channel for the users even with an FSK signaling method. By the preliminary signaling, a test is first of all carried out to determine whether one terminal or both terminals are VoIP-enabled. Only thereafter will the necessary connection data be transmitted, for which more data is to be transmitted, for example twenty signals for which, for example, 200 milliseconds are needed with an FSK method. Furthermore, when using FSK signaling, a decrease in the signaling lengths by shortening for example the FSK training sequence is feasible. This is for example also referred to as “Mark Signal” for example in ETSI EN 300 659-1 (European Telecommunications Standards Institute—European Standard).

In another development, the preliminary signaling is used. It is established that both terminals are VoIP-enabled. The signaling is therefore transmitted with the connection data, whereupon the VoIP connection is then set up. The signaling data is thus sent on the basis of the successful preliminary signaling. In other words, the connection data is sent only if a VoIP connection can indeed also be set up or is being set up by all the terminals involved.

In another development, a code is transmitted from the first terminal to the second terminal via the first telephone connection and from the second terminal back to the first terminal via the second telephone connection. The code is tested in the first terminal before the first telephone connection is cleared and/or before the second telephone connection is used, i.e. before switching takes place. If the code is not correct, then the first telephone connection shall continue to be used. For example, a VoIP-enabled telephone and a VoIP-enabled computer could be located on the side of the first terminal. By testing the code, it can be determined in the first terminal whether the VoIP connection has been set up for the correct device.

In an alternate development, a code is transmitted from the first terminal to the second terminal via the first telephone connection, and subsequently from the first terminal to the second terminal via the second telephone connection. The code is tested in the second terminal before the first telephone connection is cleared and/or before the second telephone connection is used. This serves in the same way as in the aforementioned further embodiment to determine whether the VoIP connection has been set up for the correct device.

In an alternate development, a code is transmitted from the second terminal to the first terminal via the first telephone connection, and subsequently from the second terminal to the first terminal via the second telephone connection. The code is tested in the first terminal before the first telephone connection is cleared and/or before the second telephone connection is used. This serves in the same way as in the aforementioned further embodiment to determine whether the VoIP connection has been set up for the correct device.

In an alternate development to be used, a code is transmitted from the second terminal to the first terminal via the first telephone connection and from the first terminal back to the second terminal via a second telephone connection. The code is then likewise tested, in particular in the second terminal before the first telephone connection is cleared and/or before the second telephone connection is used. The first telephone connection is for example cleared from the first terminal or from the second terminal. The code is for example a programmed device identifier, a processor code, or the like. In the case where the terminal represents a PBX (Private Branch Exchange), a code of the respective terminal (for example, the IPUI (Integrated Portable User Identity) of a DECT mobile part) can for example be used as device identifier.

In another development, the signaling is generated automatically in the space of less than one second or less than 500 or less than 100 milliseconds after setting up a voice connection of the first telephone connection. Using this measure firstly makes it possible if necessary to change to the VoIP connection at a very early point in time, and secondly a signaling perceived as a disturbance possibly takes place at the beginning of the call instead of in the middle of the call and for this reason is therefore found to be less disturbing.

In another development, the signaling takes place via the following:

DTMF (Dual Tone Multiple Frequency) in the voice channel,

FSK (Frequency Shift Keying) in the voice channel, or

signaling via a control channel, for example per UUS (User-to-User Signaling) in the ISDN.

The kinds of signaling mentioned are in any event often present in the terminals, so that they can be adapted in a simple manner to carry out the method or one of its further embodiments.

In another development, the packet-switched network operates in accordance with the Internet Protocol so that the second telephone connection is established in particular on a higher protocol layer than the Internet protocol layer. In a development, the circuit-switched telephone network switches through lines, as is the case with a similar telephone network, or voice channels, as is for example the case with a digital telephone network or with a mobile radio network.

Also described below are apparatuses, which are suitable for carrying out the method or one of its embodiments. For this reason, the above-mentioned technical effects also apply to the apparatuses.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a block diagram of a telecommunications network,

FIG. 2 is a signal timing diagram of the signaling flow between two telephones in accordance with a first exemplary embodiment, and

FIG. 3 is a signal timing diagram of the signaling flow between two telephones in accordance with a second exemplary embodiment.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

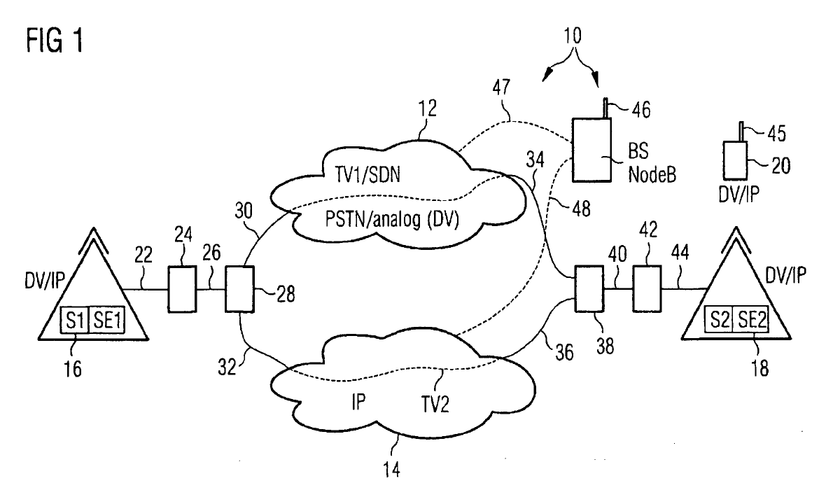

FIG. 1 shows a telecommunications network 10, which contains a circuit-switched network 12 and a packet-switched network 14. The circuit-switched network is for example as follows:

an ISDN network,

an analog telephone network,

a PSTN network (Public Switched Telephone Network).

The packet-switched network 14 is for example a network which operates in accordance with IP, in particular the Internet.

In the exemplary embodiment there are three telephones 16 to 20, which can process both telephone data which is transmitted by a circuit-switched connection or by a circuit-switched data transmission path and, on the other hand, telephone data which is transmitted by a connection of a packet data network, in particular by a transmission path to a packet-switched network.

The telephone 16 is a fixed network telephone and contains a control unit S1 as well as a transmitting unit and a receiving unit SE1. The control unit S1 for example contains a processor, which carries out a program. Alternatively the control unit S1 is made with the help of an electronic circuit, which does not contain a processor. The transmitting unit/receiving unit SE1 is for example embodied as an electronic circuit.

The telephone 16 is connected via a line 22 to a separation unit 24, which is also referred to as a splitter unit. A connecting line 26 leads from the separation unit 24 to a network-based separation unit 28. The separation unit 28 is for example located in a switching center or in a so-called DSLAM (Digital Subscriber Line Access Multiplexer). A line 30 leads from the separation unit 28 to the circuit-switched network 12. A line 32 leads from the separation unit 28 to the packet-switched network 14.

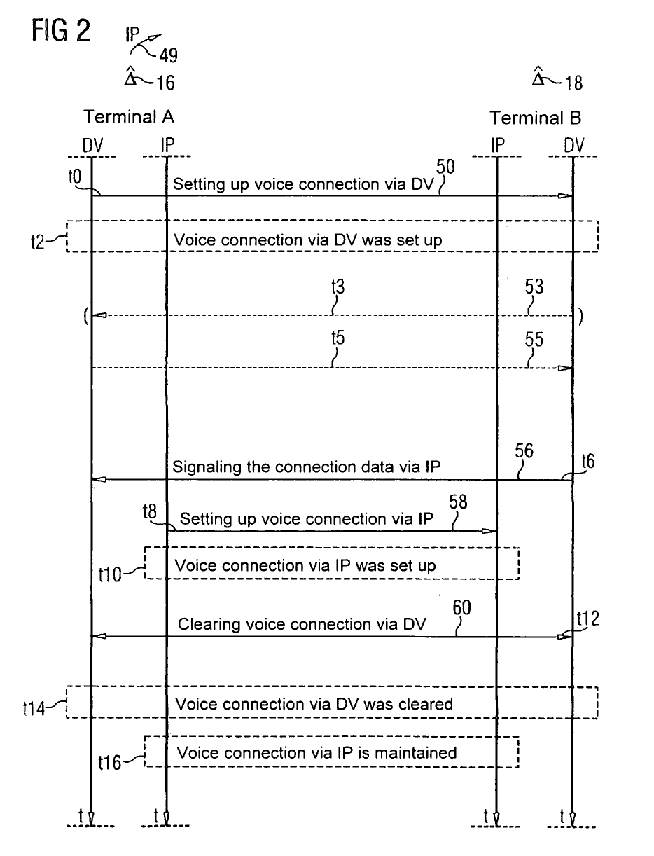

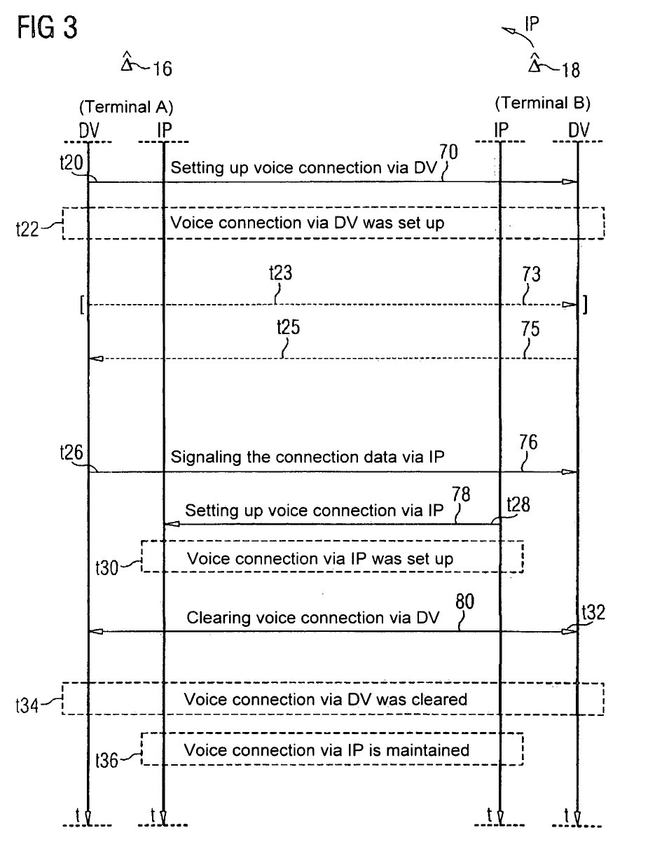

As described in more detail below on the basis of FIGS. 2 and 3, a telephone connection TV1 is first of all set up to terminal 18 in the circuit-switched network 12, with the line 30 and a line 34 being used to telephone 18. After having set up a telephone connection TV1, a VoIP telephone connection TV2 is set up, which leads through to the packet-switched network 14, with the line 32 and a line 36 being used. The line 34 and the line 36 lead to a separation unit 38, which is for example contained in a switching center or a DSLAM. A connecting line 40 leads from the separation unit 38 to a subscriber-sided separation unit 42. The separation unit 42, in the same way as the separation units 24, 28 and 38, carry out a separation or a bringing together of two frequency bands. Circuit-switched telephone data is transmitted in a lower frequency band. However, data packets are transmitted in a higher frequency band, in particular in accordance with a DSL method. Multi-frequency carrier methods are for example used for the transmission.

A line 44 leads from the separation unit 42 to the telephone 18, which in the exemplary embodiment is likewise a fixed network telephone. The telephone 18 contains a control unit S2, which can be implemented with a processor or also without a processor. In addition, the telephone 18 contains a transmitting unit/receiving unit SE2, which is controlled by the control unit S2.

In another exemplary embodiment, a mobile radio telephone 20 which can likewise handle circuit-switched telephone calls and, on the other hand, can also conduct VoIP calls, is used instead of the telephone 18. The mobile radio telephone 20 is also referred to as a mobile phone and contains a control unit which is not shown as well as an antenna 45. The telephone 20 is connected to a base station BS via a radio transmission path, see antenna 46. The base station BS is for example a base station of a GSM network (Global System Mobile) or a station of a UMTS network (Universal Mobile Telecommunication System), which is also referred to as node B. Via a line 47, the base station BS is for example connected indirectly or directly to the circuit-switched network 12. A line 48 connects indirectly or directly the base station BS to the packet-switched network 14.

FIG. 2 shows the signaling flow between the telephone 16 and the telephone 18. In this process, the telephone 16 is the calling telephone and the telephone 18 is the called telephone as regards the two telephone connections TV1, TV2, see also arrow 49.

At a point in time t0, the telephone 16 sends a connection setup request 50 to the telephone 18, with signaling for the circuit-switched network 12 being used, for example an ISDN signaling, in which not represented switching centers are included. A setup message is for example generated by the telephone 16. The telephone 18 confirms the messages in a well known way and sends after lifting the handset, for example, a connect message to its switching center. The IAM message (Initial Address Message) and the ANM message (Answer Message) are for example signaled between the switching centers for example in accordance with ISUP (ISDN User Part).

At a point in time t2, the voice connection is then set up via the circuit-switched network 12. For example, even before one of the two subscribers starts talking, a signaling 56 is already generated automatically by the called telephone 18, for example with the help of an FSK method in less than 100 milliseconds. With signaling 56, the connection data of the telephone 18 is transmitted by the packet-switched network 14 and if necessary stored in a directory file of the telephone 16, for example a so-called URI (Uniform Resource Identifier). A subscriber number and/or a character sequence are for example transmitted, for example, 08 . . . @Freinetz.de or Mr.Maier_Telephone@Freinetz.de. This takes place at a point in time t6.

A transmission of VoIP subscriber numbers/VoIP-URIs has the advantage over the transmission of addresses, in that

(a) this data is rather of a permanent nature and is therefore suitable for storage in a local memory of the terminal and for later use (unlike the IP address, the VoIP subscriber number/VoIP-URI of the subscriber does not normally change regularly) and

(b) possible NAT problems (Network Address Translation) and firewall problems can be avoided in the case of the VoIP connection setup. It is therefore conceivable that a terminal operated behind a NAT sends the locally assigned IP address and not the publicly attainable address, and for this reason a VoIP call setup fails.

The control unit S1 of the telephone 16 initiates, due to the receipt of signaling 56, the attempt of telephone 16 to set up a voice connection via the packet-switched network 14. This can take place with or without a further inquiry at the A subscriber (calling subscriber). In this process, an SIP account (Session Initiation Protocol) of the telephone 16 is for example used. The control unit S1 generates at a point in time t8 for, for example, a so-called SIP proxy server in the data transmission path 14, a signaling 58, in which it transmits the connection setup request, including for example its own address data and transmits the address of the terminal 18. The SIP proxy of a VoIP offerer then carries out further signaling steps to a computer, which is located in the proximity of the telephone 18. This computer again signals the connection setup request of the telephone 18 to the telephone 18 on the VoIP level. After the well known signaling, a voice connection is then set up via the Internet protocol. Suitable signaling protocols are as follows in particular:

SIP,

NSC (Network Based Call Signaling), or

Protocols of the H.323 protocol family of the ITU (International Telecommunication Union).

The VoIP voice data is then for example transmitted in accordance with the RTP (Real Time Transmission Protocol) in data packets via the packet-switched network 14. At a point in time t10, the telephone connection TV2 is then used by both subscribers or can be used by both subscribers so that the telephone connection TV1 is not in use starting from this point in time. Both subscribers continue to speak via the telephone connection TV2, with them not even noticing the change, if necessary.

At a point in time t12, the telephone connection TV1 is cleared. In the exemplary embodiment, the calling terminal 16 initiates the clearing process. However, as an alternative, the telephone 18 can also initiate the clearing process. For the clearing, a signaling 60 which is well known is used, for example an ISDN signaling by including the switching centers between the telephones 16 and 18.

At a point in time t14, the voice connection is cleared via the circuit-switched network 12 so that in addition no further costs are incurred for this voice connection. However, the telephone connection TV2 is maintained, see point in time t16. At the end of the call, the telephone 16 or the telephone 18 again initiates the telephone connection TV2 via the Internet in a way that is well known.

In one variant of the method, after having set up the telephone connection TV1, i.e. at a point in time t3, a signaling 53 is generated automatically, which is sent from telephone 18 to telephone 16. This is for example affected after the handset was lifted from the telephone 18 or as soon as a connection was established by the circuit-switched network 12. The signaling 53 does not contain the complete connection data but only one code or a signal, which signals that the telephone 18 is VoIP-enabled. After the reception of the signaling 53, the telephone 16 automatically generates due to this signaling at a point in time t5, a signaling 55, which has the same purpose as the signaling 53 and likewise only contains a short code or is a short code. Alternatively, signaling 55 is also automatically generated independently of signaling 53 of telephone 16, as soon as it is certain that the handset of the telephone 18 was removed or as soon as a connection has been made by the circuit-switched network 12.

However, in place of the short code, signaling 55 can also contain the connection data of the telephone 16 at the VoIP level. The telephone 18 could thus then also set up the connection via VoIP.

In another exemplary embodiment, a signaling 53 is not generated. However, the signaling 55 is generated automatically. The telephone 18 sends the signaling 56 only if it received signaling 55. On the other hand, the signaling 55 can again only contain one short code, which indicates that the terminal A is VoIP-enabled or the complete connection data of the telephone 16 with regard to VoIP.

FIG. 3 shows the signaling flow between the telephones 16 and 18 in accordance with a second exemplary embodiment. Telephone 16 is again the calling telephone, while telephone 18 is the called telephone in relation to the telephone connection TV1. However, this time the telephone 18 is the calling terminal and the telephone 16 the called terminal in relation to the telephone connection TV2.

At a point in time t20, the telephone 16 initiates the setting up of a voice connection via the circuit-switched network 12, with signaling 70 being generated, in particular by including switching centers and the terminal 18. At a point in time t22, a voice channel is set up via the circuit-switched network 12.

At a point in time t26, the telephone 16 automatically transmits, or if necessary after again asking the subscriber using the telephone 16, the connection data of the telephone 16, with this being similar connection data as used for the signaling 56, however this time in relation to the telephone 16.

As a result of receiving the signaling 76, the control unit S2 of telephone 18 initiates the setup of a VoIP voice connection at a point in time t28. In this process, a signaling 78 is carried out that corresponds to the signaling 58, but the direction of the signaling messages can different here to the case explained on the basis of FIG. 2.

At a point in time t30, a VoIP voice connection is set up via the packet-switched network 14. As soon as this VoIP connection has been set up, this connection is also used by the telephones 16 and 18, which is initiated by the control unit S1 or S2.

At a point in time t32, which is immediately after the time t30, for example in the space of a second, the clearing of the telephone connection TV1 is initiated, for example by telephone 16 or 18. At a point in time t34, the telephone connection TV1 is cleared. However, at a subsequent point in time t36, only the telephone connection TV2 between the telephones 16 or 18 still exists.

In one variant, at a point in time t23, signaling 73 is sent automatically from the telephone 16 to the telephone 18 via the telephone connection TV1. The signaling 73 does not contain the complete connection data of the telephone 16 at VoIP level, but only a code which indicates that the telephone 16 is accessible at VoIP level. On the basis of the signaling 73, the telephone 18 automatically sends a signaling 75, which likewise contains only a corresponding code or which contains the entire connection data of the telephone 18 at VoIP level.

Only after the telephone 16 has received the signaling 75 and in this way can ensure that the telephone 18 is also VoIP-enabled, is the signaling 76 generated at a point in time t26.

In another variant, a signaling 73 is not generated. However, the telephone 18 for its part generates the signaling 75, which is awaited in telephone 16 before the signaling 76 is generated. This variant prevents telephone 16 from sending the signaling 73 although it is not yet certain that the voice connection has been set up. However, the telephone 18 can assume that the voice connection has been set up, as soon as the handset was lifted, which can be detected easily.

In a further variant, which applies to the methods of both FIGS. 2 and 3, the connection data of both the telephone 16 and the telephone 18 is transmitted via the telephone connection TV1. Both telephones 16, 18 can store the connection data received in each case, in a local memory. At the next call, the call can then be automatically set up via VoIP from the beginning, regardless of which side sets up the connection.

In other exemplary embodiments, the telephone 16 and the mobile radio telephone 20 are used, however with similar signaling messages being generated, as explained above on the basis of the FIGS. 2 and 3. In further exemplary embodiments, two mobile radio telephones are used instead of the fixed network telephones 16 and 18.

In a further exemplary embodiment, if the IP address of the partner telephone has been transmitted between telephones 16 and 18, direct signaling of the call setup is undertaken, omitting the via the SIP proxy of a VoIP offerer.

As regards the VoIP security in a direct call setup between two call partners, with the security relating especially to the signaling or the call contents, i.e. the speech; it is also meaningful to transmit an identification code, in particular in both directions, for example:
A password, which is tested in the respective telephone 16, 18, with the second telephone connection TV2 only being set up in the case of a correct password,
An electronic certificate, which is tested in the telephone receiving the certificate before the second telephone connection TV2 is set up,
A so-called challenge for which a response that has previously been agreed on is sent, which differs from the challenge or which is computed from the challenge according to a method that has previously been agreed on.

In another variant before clearing the voice connection, see FIG. 2, signaling 60 or FIG. 3, signaling 80, a test is first of all carried out in order to determine whether an identification code has the correct value, which has been transmitted from the telephone 16 via the first telephone connection TV1 to telephone 18 and has been transmitted from there via the second telephone connection TV2 to the telephone 16 or in the opposite direction from telephone 16 to telephone 18 or from telephone 16 first of all via the first telephone connection TV1 and then via the second telephone connection TV2 to telephone 18, or in the opposite direction from telephone 18 to telephone 16. In this way the telephone connection TV1 is prevented from being separated, although the telephone connection TV2 was made between different telephones than the original telephones 16 and 18. Other methods can also be used in order to ensure this.

Because two independent telephone connections TV1 and TV2 are available, it is possible to implement an uninterruptible handover, by first of all completely setting up the VoIP channel, i.e. the telephone connection TV2, and only thereafter will the switched through channel or the telephone connection TV1 be cleared. In addition, in a further exemplary embodiment, the connection data stored in a local memory which was received from the other terminal is, if necessary, released by the user or automatically in a local memory. With the next call of this terminal, the call via VoIP is then set up automatically from the outset.

In summary, it applies that a definition is specified for converting an automatic handover to the less expensive VoIP call. This for example includes the following:
signaling the availability via VoIP,
the exchange of necessary data in order to make possible a safe handover towards the less expensive VoIP, and
the automatic initiation of a handover by the terminal itself.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-20. (canceled)

21. A method for setting up a telephone connection, comprising:
setting up a first telephone connection from a first terminal to a second terminal via a circuit-switched telephone network; and
sending signaling from one of the first and second terminals to the other of the first and second terminals via the first telephone connection, with the signaling indicating capability of the one of the first and second terminals also to handle telephone data which is received via a packet-switched network or containing connection data which relates to availability of the one of the first and second terminals in the packet-switched network.

22. The method as claimed in claim 21, wherein the signaling is sent automatically.

23. The method as claimed in claim 22, wherein the signaling contains all necessary connection data which relates to the availability of the one of the first and second terminals in the packet-switched network.

24. The method as claimed in claim 23, further comprising automatically setting up a second telephone connection via the packet-switched network using connection data from the other of the first and second terminals.

25. The method as claimed in claim 24, further comprising automatically clearing the first telephone connection, while the second telephone connection is in existence.

26. The method as claimed in claim 22, wherein the signaling is preliminary signaling, containing a code indicating that the one of the first and second terminals has the capability also to handle telephone data which is transmitted via the packet-switched network, the preliminary signaling containing less data than the connection data needed by the other of the first and second terminals to set up a connection via the packet-switched network to the signaling terminal and with the preliminary signaling being less than 200 ms.

27. The method as claimed in claim 24, further comprising, prior to sending the signaling, transmitting preliminary signaling containing a code indicating that the one of the first and second terminals has the capability also to handle telephone data transmitted via the packet-switched network, with the preliminary signaling containing less data than connection data needed by the other of the first and second terminals to set up a connection via he packet-switched network to the one of the first and second terminals terminal and with the preliminary signaling being less than 200 ms.

28. The method as claimed in claim 27,
wherein between the first terminal and the second terminal via the first telephone connection and between the first terminal and the second terminal via a second telephone connection, a code is transmitted that is identical in each case, and
further comprising testing the code before the first telephone connection is cleared and/or before the second telephone connection is used.

29. The method as claimed in claim 28, wherein said testing is carried out in a terminal which receives the code via the second telephone connection.

30. The method as claimed in claim 29, wherein the signaling is generated automatically less than one second after setting up a voice connection as the first telephone connection.

31. The method as claimed in claim 30, wherein the signaling takes place via DTMF, FSK or a signaling channel, and/or that the signaling of the connection data is less than one second.

32. The method as claimed in claim 31, wherein the packet-switched network operates in accordance with an Internet Protocol, and/or that the circuit-switched telephone network switches through lines or voice channels.

33. The method as claimed in claim 27, wherein the first telephone connection and the second telephone connection relate to only voice telephony and not to video telephony.

34. The method as claimed in claim 27, wherein the second telephone connection is directly set up between the terminals without inclusion of a computer of a VoIP service provider.

35. The method as claimed in claim 34, wherein between the first terminal and the second terminal, at least one password date, one challenge date or one certificate date is exchanged.

36. The method as claimed in claim 35, further comprising:
storing at least one of the signaling and connection data contained in the signaling; and
automatically reading the connection data if, after clearing of the first telephone connection, a further telephone connection is to be set up.

37. An apparatus used in conjunction with a circuit-switched telephone network and a packet-switched network, comprising:
a transmitting unit; and
a control unit initiating, via said transmitting unit and via a first telephone connection of the circuit-switched telephone network, automatic sending of signaling that indicates capability of said apparatus to also handle telephone data which is received via the packet-switched network, or the signaling containing connection data which relates to availability of a signaling terminal in the packet-switched network.

38. The apparatus as claimed in claim 37,
further comprising a receiving unit, and
wherein said control unit handles signaling received by said receiving unit via a first telephone connection of the circuit-switched telephone network and indicating the capability of another apparatus also to handle telephone data which is received via the packet-switched network or where the signaling contains connection data which relates to the availability of the signaling terminal in the packet-switched network.

39. The apparatus as claimed in claim 38, further comprising a unit performing the method recited in claim 21.

40. The apparatus as claimed in claim 39, wherein the apparatus is a telecommunications facility for more than three subscribers and less than 15 subscribers, operating in accordance with a cordless method implementing the DECT standard.
